(19) United States
(12) Patent Application Publication
(10) Pub. No.: US 2019/0285054 A1
(43) Pub. Date: Sep. 19, 2019

(54) AN APPARATUS FOR HEATING A LIQUID

(71) Applicant: H20 TURBINES LTD, Stanford-le-Hope, Essex (GB)

(72) Inventors: Ian Dalziel, Stanford-le-Hope, Essex (GB); Clifford Spilsbury, Deeside Flintshire (GB)

(21) Appl. No.: 16/464,056

(22) PCT Filed: Nov. 27, 2017
(86) PCT No.: PCT/GB2017/053559

§ 371 Date: May 24, 2019

(30) Foreign Application Priority Data
Nov. 28, 2016 (GB) 1620052.9

(51) Int. Cl. F03D 9/22; F03D 9/28

(52) U.S. Cl. CPC F03D 9/22; F05B 2250/25; F03D 9/28

(57) ABSTRACT

There is provided an apparatus (100) for heating a liquid, comprising a wind turbine (1), a pump (5), and a circuit of piping. The wind turbine (1) drives the pump (5) to pump the liquid around the circuit of piping, and the circuit of piping comprises a friction pipe (14) through which the liquid is forced by the pump (5). Friction between the liquid and an inside of the friction pipe (14) generates heat, which gradually raises the temperature of the liquid by at least 20° C.

The present invention relates to an apparatus for heating a liquid, for example using wind power.

### BACKGROUND OF THE INVENTION

Domestic residences and industrial installations commonly require liquid heating apparatuses to provide hot liquid for circulating through radiators to heat rooms, or for providing hot water supplies. There is a desire to heat the liquid as economically as possible, and solar energy systems to perform such heating are well known.

Another type of renewable energy source which can be used to heat liquids is wind power. Typically, a wind turbine is used to derive an electrical generator, and an electrical heating element is used to warm the liquid. However, this system is inefficient, and not as common as solar power.

It is therefore an object of the invention to provide an improved apparatus for heating a liquid.

### SUMMARY OF THE INVENTION

According to a first aspect of the invention, there is provided an apparatus for heating a liquid, comprising a source of rotational motion, a pump, and a circuit of piping, wherein the source of rotational motion drives the pump to pump the liquid around the circuit of piping, and wherein the circuit of piping comprises a friction pipe through which the liquid is forced by the pump, wherein friction between the liquid and an inside of the friction pipe generates heat which gradually raises the temperature of the liquid by at least 20° C.

Since friction between the liquid and the inside of the friction pipe is used to heat the liquid, there is no need for an electrical generator, and the process becomes much more efficient. To help maximise the heating of the liquid, the pump is preferably a high-flow, low-pressure centrifugal pump, and the rotational source may rotate an impeller of the pump. For example, the centrifugal pump may be limited to being rotated at a maximum speed of 1500 rpm or less. One of the ways in which the maximum speed limit may be enforced is to stop the wind turbine from turning when the wind speed rises above a certain level, as will be apparent to those skilled in the art.

The use of a centrifugal pump is particularly advantageous because centrifugal pumps present very little turning resistance to the source of rotational motion when the pump is being started up, for example this allows the blades of a wind turbine to easily start rotating as the wind speed builds up.

Clearly, any conventional piping circuit such as a central heating system will have some friction and therefore some heating affect upon the liquid flowing through it, however the source of rotational motion, pump and friction pipe of the present invention are configured so that friction between the liquid and the inside of the friction pipe will raise the temperature of the liquid by at least 20° C. under normal operating conditions, so that heating by friction can be usefully employed.

Preferably, the source of rotational motion is a wind turbine comprising blades which spin under windy weather conditions, and the rotational motion of the spinning blades is received at the pump via one or more rotating shafts, to rotate the pump and drive the liquid through it. In an alternative implementation, the pump may be driven by another source of rotational motion, for example a water wheel.

The friction pipe typically houses one or more blocking elements around which the liquid is forced to generate the heat. To provide a high level of friction between the liquid and the blocking elements, the blocking elements may comprise first and second rods that together form a double helix, and a plurality of rods joined from the first rod to the second rod and spaced apart from one another along an axis of the double helix, wherein the axis of the double helix is aligned along a length of the friction pipe.

The pump may be allowed to turn at whatever speed is dictated by the wind turbine, without any need for electronic control to regulate pump speed. This makes the wind turbine and pump simple and relatively cheap to manufacture. To avoid overheating or boiling of the liquid, the circuit of piping preferably further comprises an overtemperature protection piping loop. Then, the circuit of piping further comprises a liquid reservoir and a temperature controlled valve, and the temperature controlled valve is configured to divert the liquid out of the circuit of piping and into the overtemperature protection piping loop when a temperature of the liquid rises above a safety threshold. The overtemperature protection piping loop comprises a heat dispersion element, and returns the liquid to the reservoir once it has passed through the heat dispersion element.

The circuit of piping may comprises at least one radiator for radiating heat into a room of a building, and/or a heat exchanger pipe which passes through a water cylinder to heat water stored in the water cylinder.

### DETAILED DESCRIPTION

Embodiments of the invention will now be described by way of non-limiting example only and with reference to the accompanying drawings, in which:

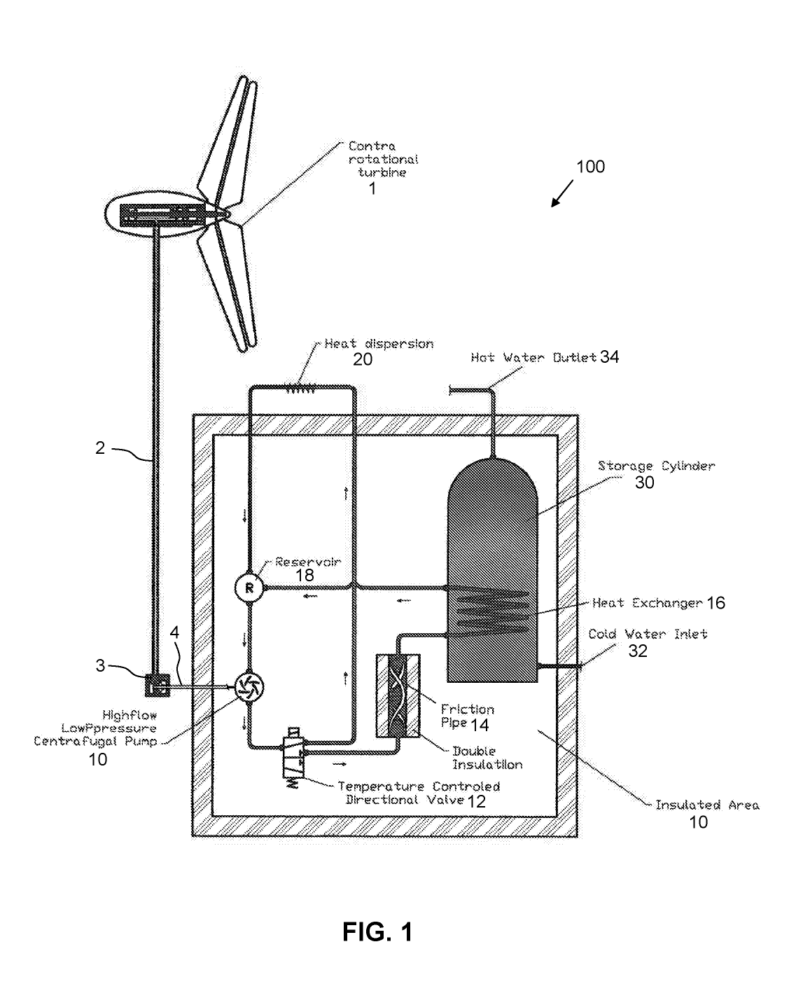

FIG. 1 shows a schematic diagram of a water heating apparatus according to an embodiment of the invention; and

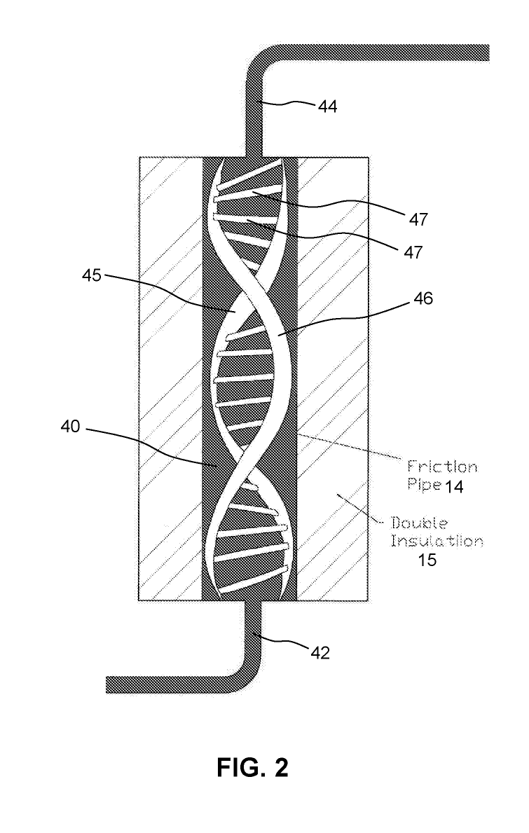

FIG. 2 shows an enlarged schematic diagram of a friction pipe of the apparatus of FIG. 1.

The figures are not to scale, and same or similar reference signs denote same or similar features.

An embodiment of the invention will now be described with reference to FIGS. 1 and 2, which show an apparatus 100 for heating liquid that is passed through a heat exchanger, to raise the temperature of water in a hot water storage cylinder.

The apparatus 100 comprises a wind turbine 1 with blades that rotate an output shaft 2 of the turbine. The output shaft 2 is connected to a gearbox 3, and the gearbox 3 has an output shaft 4 connected to a high-flow, low-pressure centrifugal pump 5. The gearbox 3 rotates the output shaft 4 at a multiple of the rotation speed of the output shaft 3. In this particular embodiment, the gearbox has a ratio of 1:6. The centrifugal pump is a single pole centrifugal pump, and is limited to a maximum speed of 1400 rpm. The pump therefore operates quietly to improve its suitabilty for installation in residential areas.

A circuit of piping is provided inside an insulated area 10, for example inside a cupboard of a house. The circuit of piping comprises the pump 5, a temperature controlled directional valve 12, a friction pipe 14, a heat exchanger 16, a reservoir 18, a pipe connected from the output of the pump 5 to the temperature controlled directional valve 12, a pipe connected from the temperature controlled directional valve 12 to the friction pipe 14, a pipe connected from the friction pipe 14 to the heat exchanger 16, a pipe connected from the heat exchanger 16 to the reservoir 18, and a pipe connected from the reservoir 18 back to the input of the pump 5. Accordingly, liquid flows around those elements in a circuit, from the output of the pump 5 and back to its input.

The friction pipe 14 has an inside comprising a plurality of blocking elements, such as rods and/or plates with apertures, via which the fluid is passed. A more detailed discussion of the inside of the friction pipe 14 is provided further below with reference to FIG. 2. The pump 5 pumps liquid around the circuit, and friction between the liquid and the inside of the friction pipe 14 causes the temperature of the liquid to gradually rise. In this embodiment the liquid is a combination of water and antifreeze, although other liquids could be used instead.

The heat exchanger 16 is formed by a coiled pipe through which the liquid passes, and the heat exchanger 16 is inside of a storage cylinder 30, which stores water. The storage cylinder 30 has an inlet 32 for cold water, and an outlet 34 for hot water. The heat exchanger 16 transfers heat in the liquid flowing through the coiled pipe to the water inside the storage cylinder 30.

The reservoir 18 provides a small volume of liquid storage, so that sufficient liquid to circulate around the circuit is always available. In use, the pump 5 pumps liquid from its output to the temperature controlled valve 12, then to the friction pipe 14, then through the heat exchanger 16, then to the reservoir 18, and then back to the input of the pump 5.

In tests carried out by the Applicant, the temperature of the liquid was found to rise beyond safe limits for high pump speeds, and so in this embodiment the apparatus further comprises an overtemperature protection piping loop, to help cool the liquid down when it becomes too hot. Specifically, the temperature controlled valve 12 diverts the liquid out of the circuit of piping and towards a heat dispersion element 20 instead of the friction pipe 14, when the temperature of the liquid rises above 65° C. The heat dispersion element 20 is outside of the insulated area 10 and in this embodiment is a long section of piping outside of the house to cool the liquid passing through the heat dispersion element 20. Once the liquid has passed through the heat dispersion element 20, it returns to the reservoir 18, where it re-enters the piping circuit. In an alternative embodiment, the heat dispersion element 20 may be within a larger heat storage area, for example within the foundations of the building.

The friction pipe 14 will now be described in more detail with reference to FIG. 2. As shown in FIG. 2, the heat pipe 14 comprises an inlet 42 and an outlet 44, and an inside 40 through which the liquid flows. The friction pipe 14 is doubly insulated around its circumference with insulation 15, to avoid heat loss. The friction pipe 14 comprises blocking elements in the form of first and second rods 45 and 46 which are arranged in a double helix, and multiple rods 47 which connect from the first rod 45 to the second rod 47 and which are spaced apart from one another along the axis of the double helix. As the liquid flows quickly around the rods 45, 46, and 47, a large amount of frictional heating occurs, raising the temperature of the liquid. This arrangement of blocking elements has been found to be particularly effective, however any elements which provide friction against the liquid flowing through the pipe can be utilised to raise the temperature of the liquid flowing through the pipe.

Many other variations of the described embodiments falling within the scope of the appended claims will be apparent to those skilled in the art, for example the closed piping circuit may include a radiator for radiating heat into rooms of a building.

1. An apparatus for heating a liquid, comprising a source of rotational motion, a pump, and a circuit of piping, wherein the source of rotational motion drives the pump to pump the liquid around the circuit of piping, and wherein the circuit of piping comprises a friction pipe through which the liquid is forced by the pump, wherein friction between the liquid and an inside of the friction pipe generates heat which gradually raises the temperature of the liquid by at least 20° C.

2. The apparatus of claim 1, wherein the source of rotational motion is a wind turbine comprising blades which spin under windy weather conditions.

3. The apparatus of claim 2, wherein the rotational motion of the spinning blades is received at the pump via one or more rotating shafts, to rotate an element of the pump and drive the liquid through the pump.

4. The apparatus of claim 1, wherein the pump is a centrifugal pump.

5. The apparatus of claim 4, wherein the centrifugal pump is limited to a maximum rotational speed, and wherein the maximum rotational speed is 1500 rpm or less.

6. The apparatus of claim 1, wherein the friction pipe houses one or more blocking elements around which the liquid is forced to generate the heat.

7. The apparatus of claim 6, wherein the blocking elements comprise first and second rods that together form a double helix, and a plurality of rods joined from the first rod to the second rod and spaced apart from one another along an axis of the double helix, wherein the axis of the double helix is aligned along a length of the friction pipe.

8. The apparatus of claim 1, further comprising an overtemperature protection piping loop, wherein the circuit of piping further comprises a liquid reservoir and a temperature controlled valve, and wherein the temperature controlled valve is configured to divert the liquid out of the circuit of piping and into the overtemperature protection piping loop when a temperature of the liquid rises above a safety threshold, the overtemperature protection piping loop comprising a heat dispersion element and returning the liquid to the reservoir once it has passed through the heat dispersion element.

9. The apparatus of claim 1, wherein the circuit of piping comprises at least one radiator for radiating heat into a room of a building.

10. The apparatus of claim 1, wherein the circuit of piping comprises a heat exchanger pipe which passes through a water cylinder to heat water stored in the water cylinder.
